(19) United States
(12) Patent Application Publication
(10) Pub. No.: US 2003/0049038 A1
(43) Pub. Date: Mar. 13, 2003

(54) Electrophotographic recording process control method and apparatus

(76) Inventor: Albert V. Buettner, Rochester, NY (US)

Correspondence Address: BRINKS HOFER GILSON & LIONE, P.O. Box 10395, Chicago, IL, 60611-0395, US

(21) Appl. No.: 10/235,772

(22) Filed: Sep. 5, 2002

Related U.S. Application Data
(60) Provisional application No. 60/317,614, filed on Sep. 5, 2001.

(51) Int. Cl. G03G 15/02; G03G 15/043

(52) U.S. Cl. 399/48; 399/50; 399/51

(57) ABSTRACT

The surface of an electrostatic recording member in an electrophotographic recording apparatus is charged to a standard primary charge V₀ₛ. The standard primary charge on the recording member is then modulated using a first test exposure E₁ to form a first exposed test area, and using a second test exposure E₂ to form a second exposed test area. A first test surface potential V₁ is measured in the first exposed test area and a second test surface potential V₂ is measured in the second exposed test area. A measured intrinsic sensitivity bₘ associated with the recording member is calculated using V₁ and V₂. A measured intrinsic toe dₘ associated with the recording member also is calculated using V₁ and V₂. A corrective charge parameter V₀ᵢ is calculated using dₘ, and a corrective exposure parameter E₀ₗ is calculated using bₘ and dₘ. V₀ is then adjusted to equal V₀ᵢ, and E₀ is adjusted to equal E₀ᵢ.

### RELATED APPLICATIONS

Applicants hereby claim priority under 35 U.S.C. §119(e) to provisional U.S. patent application Ser. No. 60/317,614, filed on Sep. 5, 2001, and incorporated herein by reference.

### BACKGROUND OF THE INVENTION

This invention relates to electrophotographic document copiers and/or printers and more particularly to automatic adjustment of parameters influencing reproduction by such copiers or printers.

In typical commercial electrophotographic reproduction apparatus (copier/duplicators, printers, or the like), a latent image charge pattern is formed on a uniformly charged, charge-retentive, photoconductive recording member. Pigmented marking particles are attracted to the latent image charge pattern at a developing station to develop such image on the recording member. A receiver member, such as a sheet of paper, transparency or other medium, is then brought into contact with the recording member, and an electric field applied to transfer the marking particle developed image to the receiver member from the recording member. After transfer, the receiver member bearing the transferred image is transported away from the recording member, and the image is fixed (fused) to the receiver member by heat and pressure to form a permanent reproduction thereon.

The contrast density and color balance (in color machines) of electrophotographic reproduction apparatus frequently vary depending on a variety of factors. Some of these factors, such as the sensitometry of the recording member, are intrinsic to the recording apparatus. Other factors, such as the ambient humidity and the charge density of the marking particles, are extrinsic to the reproduction apparatus.

To compensate for these factors, the contrast density and color balance of a copier or printer can be adjusted by changing certain process control parameters such as primary voltage V₀ and global exposure E₀. Control of such parameters is often based on measurements of the density of a marking particle image in a test patch. Typically, the test patch can be recorded on an area of the electrostatic recording member between adjacent image frames and developed. The developed density of the patch can be measured and adjustments made accordingly.

Existing methods and apparatus for adjusting V₀ and E₀ are limited in that they attempt to adjust for all factors affecting contrast density and color balance collectively. Compensating for all factors collectively is complicated because the separate effects of the various factors are confounded, and therefore it is difficult to achieve extremely low margins of error. Accordingly, there is a need for a method and apparatus for adjusting V₀ and E₀ that isolate variations in contrast density and color balance that are caused by different factors so that corrections can be made for independent factors independently.

Many existing methods and apparatus are also limited in that they require an iterative process to adjust V₀ and E₀ to acceptable levels, thereby expending substantial amounts of time and marking particles during the adjustment process. Accordingly, there is a need for a method and apparatus for adjusting V₀ and E₀ in which the corrective changes are not iterative.

Current high-speed reproduction apparatus place a further limitation on process control methods for adjusting V₀ and E₀. The high-speed nature of typical reproduction apparatus requires on-board corrective calculations that can be performed quickly during reproduction. This precludes the real-time resolution of transcendental equations to adjust V₀ and E₀ because the necessary calculations require too much time. Accordingly, there is a need for a method and apparatus for adjusting V₀ and E₀ that includes linear equations for calculating corrective changes.

It is therefore an object of the present invention to provide a process control method and apparatus that isolates variations in the sensitometry of the recording member and compensates for these variations. It is also an object of this invention to provide a process control method and apparatus that compensates for variations in the sensitometry of the recording member without requiring iterative corrective changes to V₀ and E₀. It is yet another object of this invention to provide a process control method and apparatus in which any necessary real-time calculations for corrective changes to V₀ and E₀ are based on linear equations.

### BRIEF SUMMARY OF THE PREFERRED EMBODIMENTS

In accordance with the present invention, an improved electrophotographic recording process control method and apparatus are provided.

According to one aspect of the present invention, an electrophotographic reproduction apparatus is provided. The reproduction apparatus includes an electrostatic recording member for supporting an electrostatic image. A charging station is provided for establishing a primary charge on the recording member, the primary charge being defined by a parameter V₀. An exposing station having an exposure parameter E₀ modulates the primary charge to form an electrostatic image on the recording member. A measuring device measures an exposed surface potential of the recording member after modulation by the exposing means. A controller adjusts the parameters V₀ and E₀ by directing the charging station to establish a standard primary charge V_{0S} on the recording member, directing the exposing station to modulate the primary charge to form a first electrostatic control patch using a first test exposure level E₁ and a second electrostatic control patch using a second test exposure E₂. The controller also directs the measuring device to measure a first test surface potential V₁ of the first control patch and a second test surface potential V₂ of the second control patch. The controller calculates a measured intrinsic sensitivity bₘ and an intrinsic toe dₘ associated with the recording member using V₁ and V₂. The controller also calculates a corrective charge parameter V₀ₗ using dₘ, and a corrective exposure parameter, E₀ᵢ, using bₘ and dₘ. The controller adjusts V₀ to equal V₀ᵢ, and adjusts E₀ to equal E₀ᵢ.

According to another aspect of the present invention, a method of controlling an electrophotographic reproduction process is provided. The surface of an electrostatic recording member in an electrophotographic recording apparatus is charged to a standard primary charge V₀ₛ. The standard primary charge on the recording member is then modulated using a first test exposure E₁ to form a first exposed test area, and using a second test exposure E₂ to form a second exposed test area. A first test surface potential V₁ is measured in the first exposed test area and a second test surface potential V₂ is measured in the second exposed test area. A measured intrinsic sensitivity bₘ associated with the recording member is calculated using V₁ and V₂. A measured intrinsic toe dₘ associated with the recording member also is calculated using V₁ and V₂. A corrective charge parameter V₀ᵢ is calculated using dₘ, and a corrective exposure parameter E₀ₗ is calculated using bₘ and dₘ. V₀ is then adjusted to equal V₀ₗ, and E₀ is adjusted to equal E₀ᵢ.

According to yet another aspect of the present invention, a method is provided for determining a linear equation for approximating a measured intrinsic sensitivity, bₘ, of a photoconductor charged to a primary charge, V₀, in an electrophotographic recording apparatus. A first exposure E₁, and a second exposure, E₂, are selected. A plurality of random sensitometric pairs, are then generated, wherein each of the random sensitometric pairs includes a random intrinsic sensitivity, b_{rand}, and a random intrinsic toe, d_{rand}. A plurality of surface potential pairs are then calculated using the plurality of random sensitometric pairs, wherein each of the surface potential pairs includes a first photoconductor surface potential, V₁, calculated using the first exposure, E₁, and a second photoconductor surface potential, V₂, calculated using the second exposure, E₂. A set of constants, bₘ₀, bₘ₁, and bₘ₂, are then successively approximated by using the plurality of surface potential pairs in the linear equation bₘ=bₘ₀+bₘ₁*V₁+bₘ₂*V₂, to calculate a plurality of measured intrinsic sensitivities, bₘ, and by and selecting bₘ₀, bₘ₁, and bₘ₂ to minimize the variance between the plurality of measured intrinsic sensitivities, bₘ, and the plurality of random intrinsic sensitivities.

According to still another aspect of the present invention, a method is provided for determining a linear equation for approximating a measured intrinsic toe, dₘ, of a photoconductor charged to a primary charge, V₀, in an electrophotographic recording apparatus. A first exposure E₁, and a second exposure, E₂, are selected. A plurality of random sensitometric pairs are then determined, wherein each of the random sensitometric pairs includes a random intrinsic sensitivity, b_{rand}, and a random intrinsic toe, d_{rand}. A plurality of surface potential pairs are then calculated using the plurality of random sensitometric pairs, wherein each of the surface potential pairs includes a first photoconductor surface potential, V₁, calculated using the first exposure, E₁, and a second photoconductor surface potential, V₂, calculated using the second exposure, E₂. A set of constants, dₘ₀, dₘ₁, and dₘ₂, is then successively approximated by using the plurality of surface potential pairs in the linear equation dₘ=dₘ₀+dₘ₁*V₁+dₘ₂*V₂, to calculate a plurality of measured intrinsic toes, dₘ, and selecting dₘ₀, dₘ₁, and dₘ₂ to minimize the variance between the plurality of measured intrinsic toes, dₘ, and the plurality of random intrinsic toes.

The invention, and its objects and advantages, will become more apparent in the detailed description of the preferred embodiment presented below.

### BRIEF DESCRIPTION OF THE DRAWINGS

The subsequent description of the preferred embodiments of the present invention refers to the attached drawings, wherein:

FIG. 1 shows a schematic diagram depicting an electrophotographic recording apparatus employing one presently preferred embodiment of the invention;

FIG. 2 shows a schematic diagram depicting in more detail one of the imaging modules shown in FIG. 1;

FIG. 3 shows a graph of exposed photoconductor surface potential versus the logarithm of the exposure used to produce that surface potential;

FIG. 4 shows a graph of the lightness of an image developed on a receiver versus the toning potential used to produce that lightness;

FIG. 5 shows a flow diagram illustrating a method of determining two linear equations for calculating measured values of the intrinsic sensitivity and the intrinsic toe associated with a photoconductor;

FIG. 6 shows a flow diagram illustrating a method of determining two linear equations for calculating a corrective primary charge parameter and a corrective global exposure parameter; and

FIG. 7 shows a flow diagram illustrating a process control method for adjusting the primary charge and the global exposure of an imaging module to correct for variations in the intrinsic sensitivity an the intrinsic toe of the photoconductor.

### DETAILED DESCRIPTION OF THE PREFERRED EMBODIMENTS

The present invention is described below in the environment of a particular type of electrophotographic reproduction apparatus, such as the Nexpress 2100 digital production color press, commercially available from Nexpress Solutions LLC of Rochester, N.Y. However, it will be noted that although this invention is suitable for use with such machines, it also can be used with other types of electrophotographic copiers and printers. For instance, the invention is suitable for use with black and white reproduction apparatus such as the Digimaster 9110 Network Imaging System, commercially available from Heidelberg Digital L.L.C. of Rochester, N.Y.

Because apparatus of the general type described herein are well-known, the present description will be directed in particular to elements forming part of, or cooperating more directly with, the present invention.

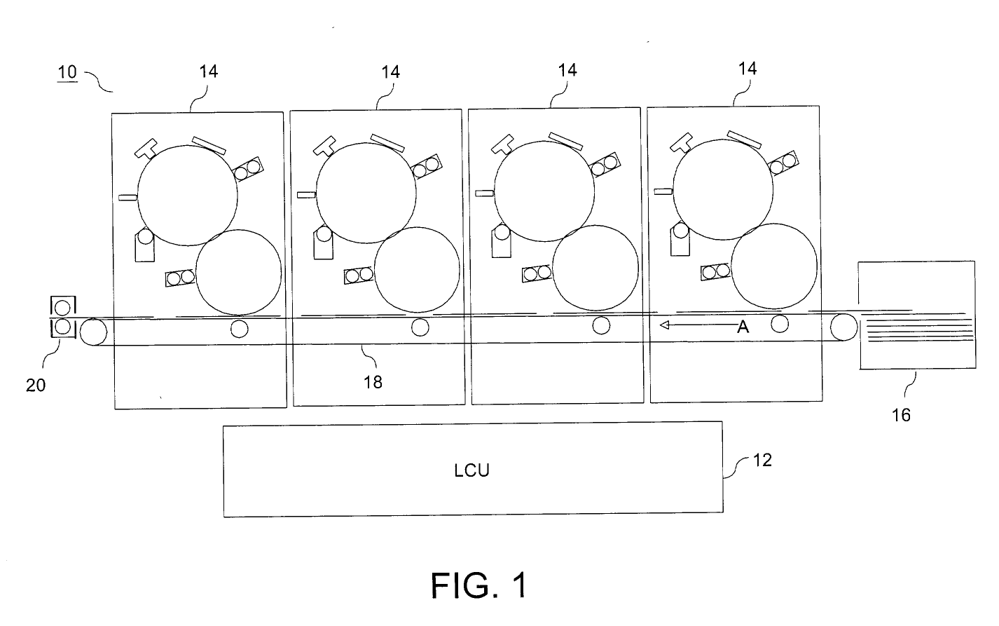

Referring now to the accompanying drawings, FIG. 1 schematically illustrates a typical electrophotographic reproduction apparatus 10 suitable for utilizing the method and apparatus of the present invention. The reproduction apparatus is described herein only to the extent necessary for a complete understanding of this invention. The electrophotographic reproduction apparatus 10 is under the control of a microprocessor-based logic and control unit 12 of any well known type. Based on appropriate input signals and programs supplied by software control algorithms associated with the microprocessor, the logic and control unit 12 provides signals for controlling the operation of the various functions of the reproduction apparatus for carrying out the reproduction process. The production of suitable programs for commercially available microprocessors is a conventional skill well understood in the art. The particular details of any such programs would, of course, depend upon the architecture of the designated microprocessor.

The reproduction apparatus 10 shown in FIG. 1 includes four imaging modules 14 for reproducing four component images to form a final composite color image. For example, each of the component images may contain image information relating to one of four component colors such as magenta, cyan, yellow, and black. It will be understood in the art that alternative reproduction apparatus may contain more or less imaging modules 14 for reproducing more or less component color images, as necessary. A similar reproduction apparatus for producing black and white images would include a single imaging module 14.

During reproduction, a receiver member such as a sheet of paper or transparency is transported from a receiver member source station to each of the imaging modules 14 by a transport member 18. The transport member 18 may include an endless web mounted on support rollers and movable about a closed loop path in the direction of the arrow A. At each imaging module 14, electrostatic pigmented marking particles, such as toner particles, forming the proper component image are transferred to the receiver member. After all four component images have been recorded onto the receiver member in this manner, the transport member 18 transports the receiver member to a fusing device 20 where the composite image is fixed to the receiver member by heat and/or pressure for example. The reproduction apparatus 10 then outputs the receiver member for operator retrieval.

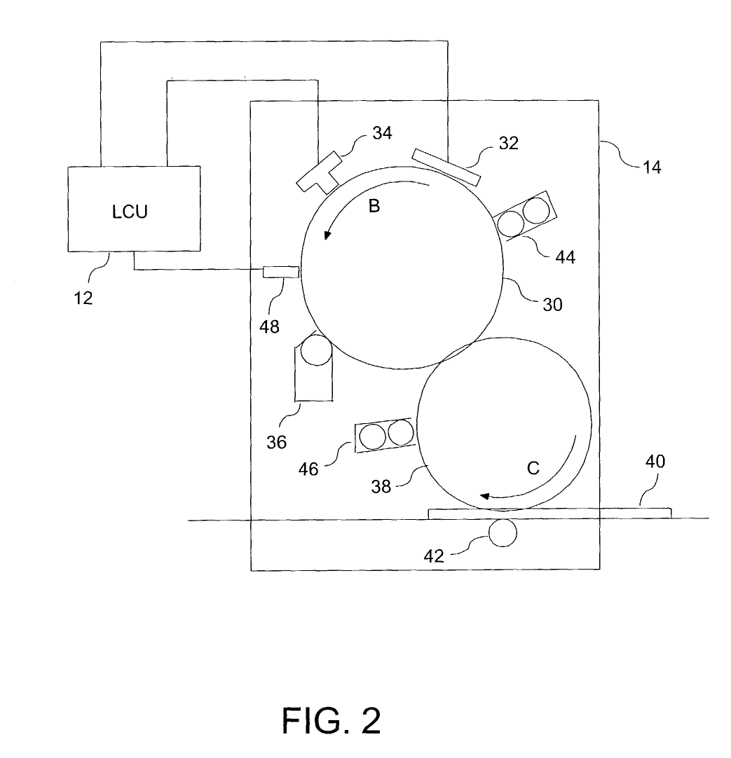

The operation of an individual imaging module 14 of the recording apparatus 10 will now be discussed with reference to FIG. 2. The imaging module 14 includes an electrostatic recording member 30. The recording member 30 shown in FIG. 2 is a thin photoconductive layer supported on a drum that is rotatable in the direction of arrow B. This type of recording member also may be referred to as a photoconductor or an imaging cylinder. Of course, this invention is suitable for use with other recording member configurations, such as photoconductive webs for example.

In the reproduction cycle for the imaging module 14, the rotating photoconductor 30 is uniformly charged as it moves past a charging station 32. Under the control of the logic and control unit 12, the charging station establishes a substantially uniform primary charge, V₀, on the photoconductor. Thereafter the uniformly charged photoconductor 30 passes an exposure station 34 where the uniform charge is altered to form a latent image charge pattern corresponding to information desired to be reproduced. Depending upon the characteristics of the photoconductor 30 and the overall reproduction system, formation of the latent image charge pattern may be accomplished by exposing the recording member 30 to a reflected light image of an original document to be reproduced, or by “writing” on the recording member 30 with a series of lamps (e.g., LED's) or scanning lasers activated by electronically generated signals based on the desired information to be reproduced. Under the control of the logic and control unit 12, the exposure station 34 typically uses a number of exposure steps based on a global exposure parameter, E₀, to achieve different levels of density in the developed image. In the case of LED or laser exposing elements, different exposure steps are typically achieved by varying the amount of time a particular LED or laser element is turned on during exposure. The electrical current that powers the LED's or lasers typically is constant for all exposure steps. The exposure current generally is changed only to adjust the global exposure parameter, E₀.

As the photoconductor 30 continues to rotate in the direction of the arrow B, the latent image charge pattern on the photoconductor 30 is brought into association with a development station 36 that applies charged pigmented marking particles to adhere to the photoconductor 30 to develop the latent image. The developing station 36 is biased with an electrical potential, V_{bias}, that produces an electrical field with respect to the photoconductor 30. The developing station bias is selected such that charged marking particles are attracted from the developing station 36 to the exposed areas of the photoconductor 30, but not to the unexposed areas.

The portion of the photoconductor 30 carrying the developed image then comes into contact with an intermediate transfer member 38. The intermediate transfer member 38 shown in FIG. 2 is an electrically biased drum that rotates in the direction of the arrow C and produces an electric field with respect to the recording member 30. This electric field attracts the marking particles forming the developed image from the photoconductor 30 to the intermediate transfer drum 38. As the intermediate transfer drum 38 continues to rotate in the direction of the arrow C, the transport web 18 moves a receiver member 40 to a nip formed between the intermediate transfer drum 38 and a transfer roller 42. Movement of the receiver 40 into the nip is timed to ensure proper registered relationship between the receiver 40 and the marking particles forming the developed image on the intermediate transfer drum 38. The transfer roller 42 is biased with a constant current to produce an electric field with respect to the intermediate transfer drum 38. This electric field attracts the marking particles forming the developed image from the intermediate transfer drum 38 to the receiver 40.

A photoconductor cleaning station 44 and an intermediate transfer drum cleaning station 46 also are shown in FIG. 2. The photoconductor cleaning station 44 operates to clean any residual marking particles or debris from the photoconductor 30 after the developed image is transferred to the intermediate transfer drum 38. Likewise, the intermediate transfer drum cleaning station 46 operates to clean residual marking particles and debris from the intermediate transfer drum 38 after transfer of the developed image to the receiver 40.

The imaging module 14 of FIG. 2 also includes a measuring device 48, such as an electrometer, for measuring the electrical potential of the photoconductor 30 after exposure at the exposing station 34. Test measurements of the exposed photoconductor potential are used as feedback when adjusting the process control parameters V₀ and E₀. To take a test measurement of the exposed photoconductor potential, the photoconductor is first charged to a standard primary charge V_{0S} at the charging station 32. The exposing station 34 then exposes the photoconductor using a pre-determined exposure E, to form an exposed test patch. Under the control of the logic and control unit 12 the electrometer 48 measures the resulting electrical potential V in the test patch of the photoconductor.

### Photodischarge and Lightness Equations

The photodischarge equation (equation 1) empirically describes the entire photodischarge curve in terms of three independent parameters associated with the photoconductor 30, the intrinsic sensitivity, b, the intrinsic contrast, c, and the intrinsic toe, d.

V=V₀*((1−d)*exp(−(b*E)^{c})+d) (1)

As described above, V₀ is the surface potential to which the photoconductor 30 is charged by the charging station 32 prior to exposure. V is the surface potential of the photoconductor after an exposure E at the exposing station 34. The parameters c and d are dimensionless. The units of b are the reciprocal of the units of exposure—typically cm²/erg. The dynamic range of the photoconductor 30 is proportional to 1/c.

The value of c is independent of V₀. The value of b decreases with increasing V₀ according to a power function of V₀, and d decreases linearly with increasing V₀. The equations for these changes from their reference values, bᵣ and dᵣ, are:

b=bᵣ*(V₀/V₀ᵣ)^{-p} (2)

and

d=dᵣ−m*(V₀−V₀ᵣ) (3)

V₀ᵣ is the reference value of V₀, which is typically 500 V. Equations 2 and 3 demonstrate the dependences of b and d on V₀. Because of these dependences, a change in the primary charge, V₀, will result in a change in both the intrinsic sensitivity, b, and the intrinsic toe, d, of the photoconductor 30. The parameters p and m may be referred to as the power dependence of the intrinsic sensitivity on V₀, and the linear dependence of the intrinsic toe on V₀, respectively.

Accordingly, given equations 1-3 and values for the five parameters bᵣ, c, dᵣ, p and m of the photoconductor 30, the complete photodischarge can be calculated as a function of exposure, E, at any V₀. Typically, such predictions of V differ from the experimental values by about 1% of the value of V₀.

For a discharged area development (DAD) process, the difference between V₀ and the electrical potential of the developing station, V_{bias}, is the background potential, BP, or offset, and the difference between V_{bias} and the surface potential, V, of the photoconductor 30 after exposure is the toning potential, TP. Thus, the toning potential is defined by the equation:

TP=V_{bias}−V (4)

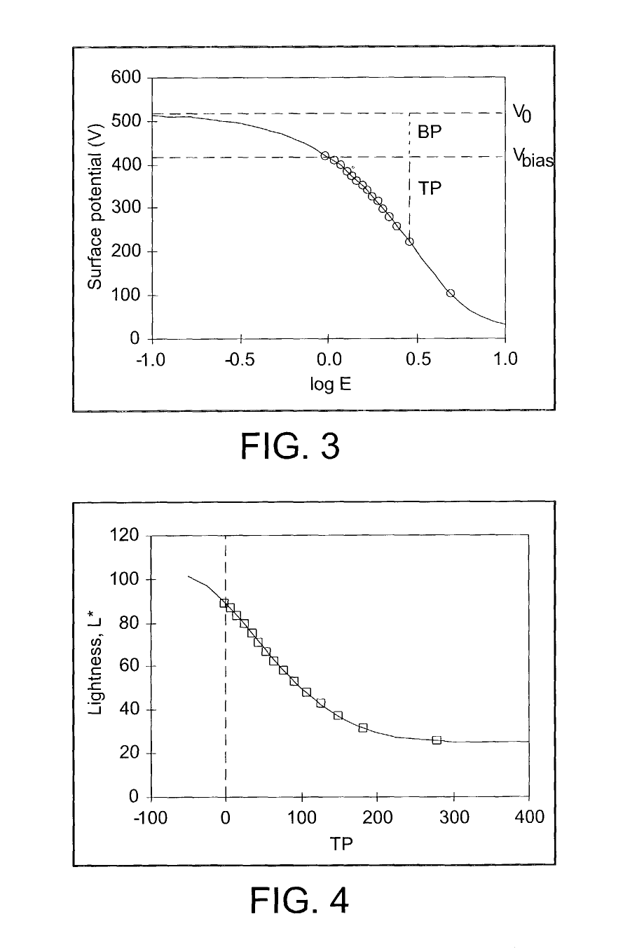

The toning potential is what attracts the charged marking particles from the developing station 36 to the photoconductor 30. In a DAD process, a higher exposure E produces a lower surface potential, V, after exposure, which results in a higher toning potential, TP. FIG. 3 illustrates the toning potential in a DAD process. The background potential, BP, is shown as the difference between V₀ and V_{bias}. The toning potential, TP, is shown as the difference between V_{bias} and the surface potential, V, produced by a particular exposure, E. For surface potentials that are less than V_{bias}, the toning potential, and therefore the amount of marking particles attracted to a particular area of the photoconductor, both increase with decreasing surface potential, V. As FIG. 3 indicates, a relatively small number of marking particles are attracted from the developing station 36 to the photoconductor 30 even when the photoconductor surface potential is slightly higher than V_{bias}. It is believed that tribocharging associated with the reproduction apparatus 10 causes this phenomenon, which occurs only within a limited voltage range above V_{bias}.

The perceived lightness, L*, of an image on a receiver ranges from 100 to 0. A decease in L* of 5 will appear the same whether it is from 85 to 80 or from 35 to 30. Equation 5 describes the lightness, L*, of an exposed area as a function of toning potential, TP.

L*=w*└(1−z)*exp(−((TP+x)/h)^{y})+z┘ (5)

FIG. 4 illustrates the relationship between lightness, L*, and toning potential, TP. The parameter w is the maximum lightness of the equation. The product of w and x approximates the minimum lightness that the developed image asymptotically approaches at very high toning potentials. The parameter x approximates an electrical potential offset. This offset is required because of the triboelectric effects that allow toning to occur at photoconductor surface potentials up to x volts above V_{bias}, despite the fact that the toning potential is negative. At photoconductor surface potentials greater than V_{bias} plus x volts, toning does not occur. A typical value of x is approximately 40 V. The parameter h is a marking particle charge factor that increases with the increasing ratio of charge to mass (Q/m) of the marking particles. As h increases, more toning potential is required to produce the same density in a developed image. The parameter y is a shaping constant that determines the degree of s-shape of the roughly exponential curve of L versus TP.

The discussion above demonstrates that the lightness, or lensity in color processes, of a developed image is determined by the toning potential irrespective of the V₀ to which the photoconductor 30 is charged before exposure. Variations in the sensitometry of the photoconductor, however, frequently cause changes in the toning potential, which affects the lightness or lensity of a developed image. Color images are particularly sensitive to these sensitometric variations. The present invention enables adjustment of the process control parameters V₀ and E₀ to maintain a constant relationship between the toning potential and a given exposure step even when the sensitometry of the photoconductor varies.

### Methods of Measuring Intrinsic Sensitivity and Toe

Before correcting for variations in photoconductor sensitometry, there must be an exact measurement of the separable independent parameters, namely the intrinsic sensitivity or speed, b, the intrinsic contrast, c, and the intrinsic toe, d. These are needed to calculate an exact correction for any variations. Since equation 1 cannot be made linear, it must be solved by successive approximation. The values of b, c, and d must be varied until the combination that minimizes the error between experimental and calculated values for a series of points in the photodischarge curve is found. At a bare minimum, there must be three points in the photodischarge curve, but eight or more points are preferable. Successive approximations are very difficult to carry out on typical electrophotographic reproduction apparatus. However, once c is determined using successive approximation, other methods can be used to determine b and d. This is because it is possible to manufacture photoconductors according to strict contrast specifications. Accordingly, c either remains constant or can be set constant with a negligible loss in the accuracy of the photodischarge equation.

One way to precisely measure the intrinsic toe, d, is to expose the photoconductor 30 with one extremely high exposure. At a very high exposure, the exposed surface potential, V, of the photoconductor 30 approaches its lower limits, and V/V₀ approaches the value of the intrinsic toe, d. The intrinsic sensitivity, b, may then be determined by exposing the photoconductor to a series of exposures that discharge the photoconductor 30 to surface potentials in the middle of the voltage range to determine the surface potential, V, that satisfies the following equation:

V=V₀*(1−d)/e+d (6)

At this surface potential, the exponential term in equation 1 is exp(−1) or 1/e, regardless of the value of c, and the product of b and E is equal to one. Accordingly, b is equal to the reciprocal of the exposure that produces this critical exposed surface potential on the photoconductor 30.

This approach is limited, however, in that it requires one very large exposure, which is rarely available with LED or laser exposing elements. This method also requires a series of exposures to identify the surface potential that facilitates solving for the intrinsic sensitivity. Finally, this approach requires an algorithm that matches surface potential values, rather than a calculation from a single measurement.

Another approach to determining the intrinsic sensitivity, b, and the intrinsic toe, d, is by inversion of the photodischarge equation (equation 1). The value of c, which typically does not vary significantly, must be known from a previous measurement of the entire photodischarge curve and successive approximation as described above. Using a single very high exposure, as described above, d can be approximated to be the resulting value of V/V₀. This approximation of d is then used in an inverted form of equation 1 to calculate b. The inverse of equation 1 is

$$E = {( - ln ( \frac{V / {V}_{0} - d}{1 - d} ) )}^{1 / c} / b \qquad ( 7 )$$

Multiplying equation 6 by b/E yields the variation

$$b = {( - ln ( \frac{V / {V}_{0} - d}{1 - d} ) )}^{1 / c} / E \qquad ( 8 )$$

Because E is known, d is approximately known, and V can be measured, the intrinsic sensitivity, b, can be calculated. This method of calculating b and d is also limited, however, in that it requires one very large exposure, which is rarely available with LED or laser exposing elements. In addition, equation 7 is a transcendental equation. Solving such transcendental equations requires more time than is typically available in high-speed electrophotographic recording apparatus, which require calculations to run at extremely high speed.

### A Simple Linear Calculation of b and d from Two Voltages

The present invention provides a method of deriving two simple linear equations that, given two sample measured exposed surface potentials, allow for accurately determining the sensitivity and toe of the photoconductor at any given time. Again, the value of c, which typically does not vary significantly, must be known from a previous measurement of the entire photodischarge curve and successive approximation as described above. Because c does not change, two linear equations for determining b and d can be derived from equation 1, a plurality of random values for b and d, and successive approximation. These linear equations allow for calculation of b and d precisely over a useful range from the measured voltages V₁ and V₂ that result from two carefully selected exposures E₁ and E₂.

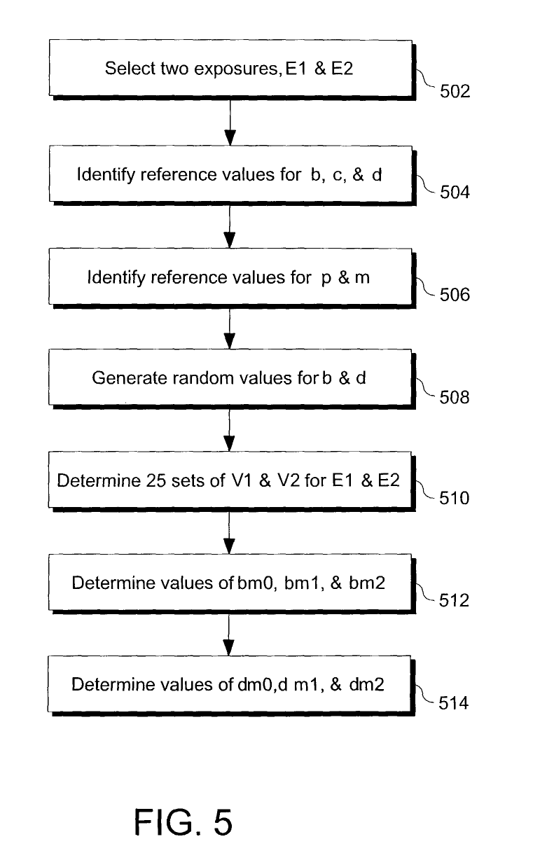

FIG. 5 illustrates the method of deriving the these linear equations. The first step 502 is to select two exposures, E₁ and E₂. Preferably, E₁ is chosen to produce an exposed surface potential, V₁, that is approximately equal to one half of the value of V₀. The second exposure, E₂, preferably is chosen to be as bright as the LED or laser exposing element can easily manage, which produces an exposed surface potential, V₂, that is relatively close to the intrinsic toe. The next step 504 is to identify reference values for b, c, and d for a V₀ of approximately 500 V. These reference values are unique to a particular design and type of photoconductor, and preferably are determined using experimental data collected from a plurality of representative photoconductors. Reference values for p and m are then determined in a similar manner for a range V₀ values in step 506. Next, a plurality of random values for b and d are generated in step 508. Preferably, twenty-five random values are generated for both b and d around their reference values. The random values for b preferably are chosen to be between 0.457 cm²/erg and 0.619 cm²/erg. The random values for d preferably are chosen to be between 0.017 and 0.260.

In step 510, for each of the twenty-five random pairs of b and d, equation 1 is used to determine V₁ and V₂ for exposures E₁ and E₂. A value of 500 V is used for V₀ for purposes of these calculations. Again, E₁ preferably is chosen to produce a V₁ of approximately 250 V with a nominal b of approximately 0.538 cm²/erg. E₂ is chosen to be a relatively high exposure that can easily be delivered by the exposing element. The sensitivity that is measured for a particular type of photoconductor is defined as bₘ. If bₘ is defined as a linear function of both V₁ and V₂, then it can be described by the equation:

bₘ=bₘ₀+bₘ₁*V₁+bₘ₂*V₂ (9)

The values of constants bₘ₀, bₘ₁, and bₘ₂ are determined in step 512 by varying them in a successive approximation that minimizes the variance between the twenty-five random values of b generated in step 508 and twenty-five values of bₘ that are calculated using equation 9 with the values of V₁ and V₂ calculated in step 510 using the transcendental equation 1.

In like manner, the toe that is measured for a particular type of photoconductor is defined as dₘ. If dₘ is defined as a linear function of both V₁ and V₂, then it can be described by the equation:

dₘ=dₘ₀+dₘ₁*V₁+dₘ₂*V₂ (10)

The values of constants dₘ₀, dₘ₁, and dₘ₂ are similarly determined in step 514 by varying them in a successive approximation that minimizes the variance between the twenty-five random values of d generated in step 508 and twenty-five values of dₘ that are calculated using equation 10 with the values for V₁ and V₂ calculated in step 510 using the transcendental equation 1.

### Correcting for Variations of b and d by Adjusting V₀ and E₀

The correction for variations in the intrinsic sensitivity, b, and the intrinsic toe, d, can be made with precision by changing the values of V₀ and E₀. It is not necessary to vary any of the individual exposure steps relative to each other. Accordingly, the value of E/E₀ for each step remains the same. A variation in b merely shifts the V versus log(E) curve along the log(E) axis with absolutely no change in the shape of the curve. Thus, if b is increased by a constant factor, for instance 1.25, then decreasing the global exposure, E₀, by multiplying it by the reciprocal of the same factor, 1/1.25, corrects for the increase in b.

The correction for a variation in d is more complicated. If d increases, then the toning potential, TP, is decreased. As a correction, TP can be increased by increasing V₀. However, because d is itself a function of V₀, the determination of a corrective V₀ is complex. In addition, the change in V₀ causes a change in b which in turn requires additional correction of the global exposure, E₀, as described above.

The process of adjusting V₀ and E₀ to correct for variations in b and d involves determining two corrective parameters V₀ᵢ and E₀ₗ. The first corrective parameter, V₀ₗ, is the value of V₀ that corrects for variations in intrinsic toe, d, of the photoconductor 30. One way to identify V₀ᵢ involves transcendental equations. First, it is necessary to introduce another parameter, the effective voltage, Vₑ. The effective voltage is the difference between V_{bias} and the toe at very high exposures, which is in turn is equal to V₀*d. Because V_{bias} is equal to the difference between V₀ and the background potential, BP, the effective voltage, Vₑ, can be defined as follows:

Vₑ=V₀−BP−V₀*d (11)

To correct for variations in the intrinsic toe, d, V₀ can be adjusted in such a way as to keep Vₑ constant and then by changing the global E₀ in such a way as to correct for the change in speed, b, induced by the change in V₀. However, determining what value of V₀ is needed to correct for variations in d is not a simple matter because d is itself a function of V₀.

The calculation of V₀ᵢ, the intermediate V₀ that corrects for variations in d, begins with a calculation of bₘ and dₘ at V₀ₛ from V₁ and V₂ using equations 9 and 10. At the standard V₀, the standard effective voltage, Vₑₛ, can be calculated from a variation of equation 11:

VₑₛV₀ₛ−BP−V₀ₛ*dₛ (12)

Then, it is necessary to calculate the value of m′, which is the value of m for a d other than dr. Because dₘ was measured at V₀ₛ, dₘ is divided by dₛ rather than dᵣ.

m′=m*dₘ/dₛ (13)

Equation 13 merely states that m′, which determines the variation of d with the variation of V₀, scales with the value of dₘ. Equation 11 can then be solved for V₀, and the terms made specific for V₀ᵢ to yield the equation:

V₀ₜ=BP+Vₑₜ+V₀ₜ*dₜ (14)

However, the value of dᵢ is also a function of V₀ₜ:

dᵢ=dₘ−m′*(V₀ₜ−V₀ₛ) (15)

Substituting the equivalent of dᵢ in equation 15 for dᵢ in equation 14 yields the equation:

V₀ₜ=BP+Vₑᵢ+V₀ₜ*(dₘ−m′*(V₀ᵢ−V₀ₛ)) (16)

Equation 16 is simply a quadratic equation in V₀ᵢ:

0=m′*V₀ₜ²+(1−dₘ−m′*V₀ₛ)*V₀ₜ+(−BP−Vₑₜ) (17)

Equation 17 can be solved by the quadratic formula:

$${V}_{0 i} = \frac{- bee \pm \sqrt{{bee}^{2} - 4 * {m}^{′} * cee}}{2 * {m}^{′}} \qquad ( 18 )$$

with

bee=1−dₘ−m′*V₀ₛ (19)

and

cee=−BP−Vₑₛ (20)

Because the effective voltage is to be kept constant, Vₑₛ replaces Vₑᵢ in equation 20.

The second corrective parameter, E₀ᵢ, is the value of E₀ that corrects for variations in both the intrinsic sensitivity, b, and the intrinsic toe, d, of the photoconductor 30. E₀ᵢ is calculated using transcendental equations. The calculation of E₀ₗ for changes in both b and d is simplified because there is no change in the effective voltage, Vₑ. The equation uses bₘ and the value of V₀ᵢ calculated from dₘ:

E₀ᵢ=E₀ₛ*(bₛ/bₘ)*(V₀ₜ/V₀ₛ)^{p} (21)

The factor (bₛ/bₘ) in equation 21 corrects the value of E₀ₛ for the variation of b from the standard bₛ to bₘ. The factor (V₀ₗ/V₀ₛ)^{p} further corrects E₀ₛ for the change in b that results from the change of V₀ₛ to V₀ₗ. For example, as V₀ₗ increases, the intrinsic sensitivity, b, of the photoconductor decreases according to the power law in equation 2. Accordingly, the corrective global exposure parameter E₀ᵢ is increased by the factor (V₀ᵢ/V₀ₛ)^{p}.

It is possible to calculate V₀ᵢ and E₀ᵢ from bₘ and dₘ using equations 18 through 21. However, as with the calculation of bₘ and dₘ described above, the use of transcendental equations is typically not feasible in high speed reproduction apparatus. Accordingly, the present invention provides a method of determining two linear equations from which V₀ₗ and E₀ᵢ can be calculated.

### A Simple Linear Calculation of V₀ᵢ and E₀ᵢ from bₘ and dₘ

The twenty-five random combinations of b and d, can be combined with equations 18 through 21 and linear regression analysis to determine two linear equations from which V₀ᵢ and E₀ᵢ can be precisely calculated from bₘ and dₘ.

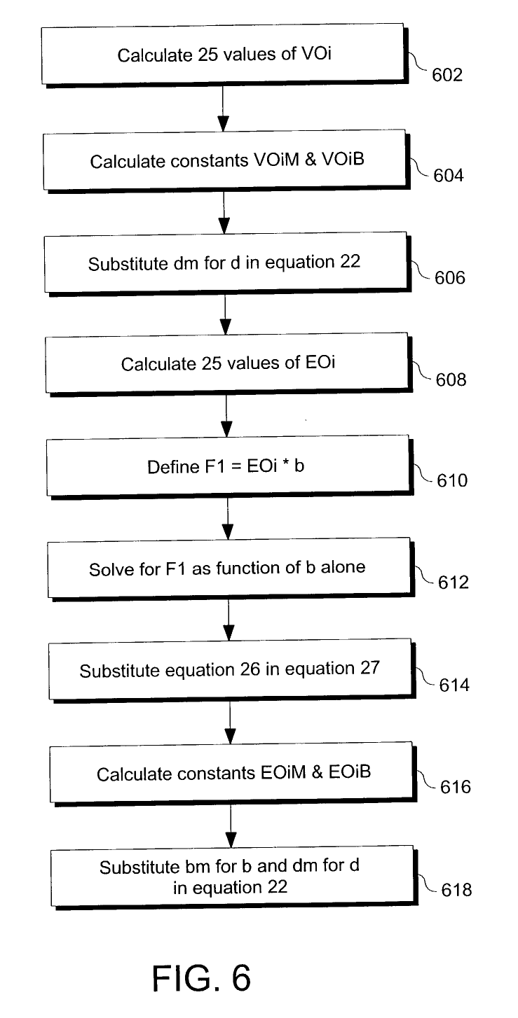

A method of determining linear equations for V₀ᵢ and E₀ᵢ will now be discussed with reference to FIG. 6. The derivation of the linear equation for V₀ₗ begins in step 602 with the calculation of twenty-five values of V₀ᵢ using equations 18 through 20 and the random values of d generated in step 508 of FIG. 5. If V₀ᵢ is a linear function of d, then it can be described by the equation:

V₀ᵢ=V_{0iM}*d+V_{0tB} (22)

Using linear regression, the constants V_{0iM} and V_{0iB} are calculated in step 604. In step 606, dₘ is substituted for d to yield a linear relationship between V₀ᵢ and dₘ:

V₀ₜ=V_{0tM}*dₘ+V_{0tB} (23)

The calculation of E₀ᵢ is more complex than the calculation of V₀ᵢ. The value of E₀ᵢ depends on both bₘ and dₘ because dₘ affects V₀ᵢ, which in turn changes the intrinsic speed, b. The calculations are simplified by introducing a parameter F₁, which removes b from the linear equation and reintroduces it later. The derivation of the linear equation for E₀ᵢ begins with the calculation in step 608 of twenty-five values of E₀ᵢ using a modified version of transcendental equation 21 and the twenty-five random values of b and d generated in step 508 of FIG. 5. The modified transcendental equation is:

E₀ᵢ=E₀ₛ*bₛ/b*(V₀ₜ/V₀ₛ)^{p} (24)

In step 610, F₁ is defined by the equation:

F₁=E₀ₜ*b (25)

Because F₁ is the product of b and an equation with b in the denominator, F₁ is not in fact a function of b. In step 612, F₁ is defined as a function of d alone, according to the following linear equation:

F₁=E_{0iM}*d+E_{0tB} (26)

A modified version of equation 25 shows that E₀ₗ also can be defined as follows:

E₀ₜ=F₁/b (27)

In step 614, equation 26 is substituted in equation 27 to yield:

E₀ᵢ=(E_{0tM}*d+E_{0tB})/b (28)

Using linear regression, the constants E_{0iM} and E_{0iB} are calculated in step 616. In step 618, dₘ is substituted for d, and bₘ is substituted for b to yield a linear relationship between E₀ₜ and both bₘ and dₘ:

E₀ₜ=(E_{0tM}*dₘ+E_{0tB})/bₘ (29)

The linear equations 23 and 29 provide a very accurate means for calculating corrective parameters V₀ᵢ and E₀ᵢ using the values for bₘ and dₘ calculated according to linear equations 9 and 10. Comparison of calculation results from linear and transcendental equations shows that using the linear equations instead of the transcendental equations adds a standard order of estimate of only about 0.2 V, or approximately 0.04% of V₀ₛ.

### A Process Control Algorithm to Correct for Variation in Photoconductor Sensitometry

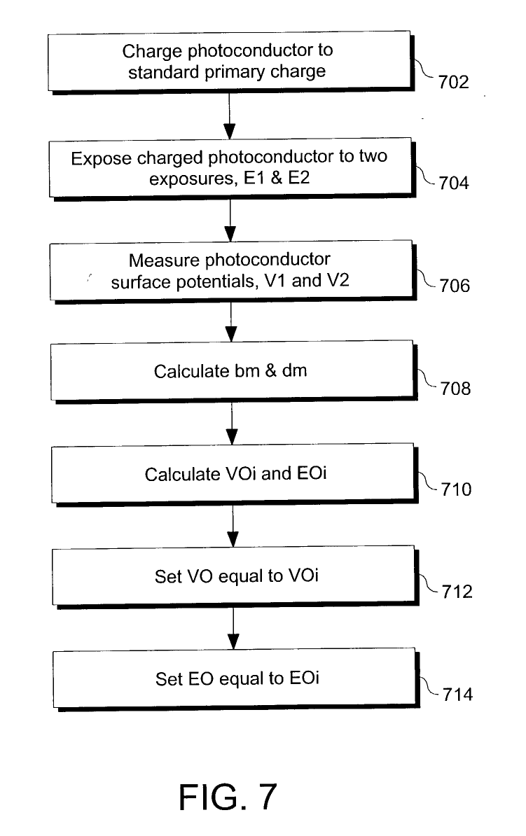

The derivations of the linear equations 9, 10, 23, and 29 and the ten linear parameters bₘ₀, bₘ₁, bₘ₂, dₘ₀, dₘ₁, dₘ₂, V_{0iM}, V_{0iB}, E_{0iM}, and E_{0iB} that are specified for a given type of photoconductor are somewhat complex and involve transcendental equations. However, once the linear equations for a given type of photoconductor have been derived for a standard V₀, the resulting method of correcting for changes in photoconductor operating sensitometry is quite simple. This process control correction method will now be described with reference to FIG. 7.

The method begins with step 702 in which the charging station 32 charges the photoconductor 30 to a standard primary charge V₀ₛ. The standard primary charge preferably is 500 V. In the next step 704, the exposing station 34 exposes the charged photoconductor 30 to two known test exposures, E₁ and E₂. The first test exposure, E₁, preferably is chosen to produce an exposed photoconductor surface potential of approximately one half the magnitude of V₀ₛ, or approximately 250 V. The second test exposure, E₂, preferably is chosen to be as high as the exposing element can easily manage. After the test exposures, in step 706, the electrometer 48 measures two photoconductor surface potentials, V₁ and V₂, that result from the test exposures. Then, in step 708, the logic and control unit 12 uses equations 9 and 10 and the two measured surface potentials, V₁ and V₂, to calculate the operating intrinsic sensitivity, bₘ, and the operating intrinsic toe, dₘ, of the photoconductor 30. The logic and control unit 12 then uses equations 23 and 29, the operating intrinsic sensitivity, bₘ, and the operating intrinsic toe, dₘ, to calculate the corrective parameters V₀ᵢ and E₀ᵢ in step 710. Then, in step 712, the logic and control unit 12 adjusts the primary charge V₀ to equal the value of the calculated corrective parameter V₀ᵢ. Finally, in step 714, the logic and control unit 12 adjusts the global exposure E₀ to equal the value of the calculated corrective parameter E₀ᵢ.

The invention has been described in detail with particular reference to preferred embodiments thereof, but it will be understood that variations and modifications can be effected within the spirit and scope of the invention as set forth in the claims.

1. An electrophotographic reproduction apparatus comprising:
an electrostatic recording member for supporting an electrostatic image;
charging means for establishing a primary charge on the recording member, the primary charge being defined by a charge parameter V₀;
exposing means for modulating the primary charge to form an electrostatic image on the recording member and having an exposure parameter E₀;
measuring means for measuring an exposed surface potential of the recording member after modulation by the exposing means; and
control means for controlling adjustments to the parameters V₀ and E₀ by directing the charging means to establish a standard primary charge V₀ₛ on the recording member; directing the exposing means to modulate the primary charge to form a first electrostatic control patch using a first test exposure level E₁ and a second electrostatic control patch using a second test exposure E₂, directing the measuring means to measure a first test surface potential V₁ of the first control patch and a second test surface potential V₂ of the second control patch, calculating a measured intrinsic sensitivity bₘ and a measured intrinsic toe dₘ associated with the recording member using V₁ and V₂, calculating a corrective charge parameter V₀ᵢ using dₘ, calculating a corrective exposure parameter E₀ᵢ using bₘ and dₘ, adjusting V₀ to equal V₀ᵢ, and adjusting E₀ to equal E₀ᵢ.

2. An electrophotographic reproduction apparatus as in claim 1, wherein:
the control means calculates the measured intrinsic sensitivity according to the equation
bₘ=bₘ₀+bₘ₁*V₁+bₘ₂*V₂; and
the control means calculates the intrinsic toe according to the equation
dₘ=dₘ₀+dₘ₁*V₁+dₘ₂*V₂;
wherein bₘ₀, bₘ₁, bₘ₂, dₘ₀, dₘ₁, and dₘ₂ are constants.

3. An electrophotographic reproduction apparatus as in claim 2, wherein:
the control means calculates the corrective charge parameter according to the equation
V₀ₗ=V₀ₗₘ*dₘ+V_{0iB}; and
the control means calculates the corrective exposure parameter according to the equation
E₀ₗ=(E_{0iM}*dₘ+E_{0iB})/bₘ;
wherein V_{0iM}, V_{0iB}, E_{0iM}, and E_{0iB} are constants.

4. A method of controlling an electrophotographic reproduction process by adjusting a primary charge parameter V₀ and a global exposure parameter E₀, comprising:
charging the surface of an electrostatic recording member in an electrophotographic recording apparatus to a standard primary charge V₀ₛ;
modulating the standard primary charge on the recording member using a first test exposure E₁ to form a first exposed test area, and using a second test exposure E₂ to form a second exposed test area;
measuring a first test surface potential V₁ in the first exposed test area and a second test surface potential V₂ in the second exposed test area;
calculating an intrinsic sensitivity bₘ associated with the recording member using V₁ and V₂;
calculating an intrinsic toe dₘ associated with the recording member using V₁ and V₂;
calculating a corrective charge parameter V₀ᵢ using dₘ;
calculating a corrective exposure parameter E₀ᵢ using bₘ and dₘ;
adjusting V₀ to equal V₀ᵢ; and
adjusting E₀ to equal E₀ᵢ.

5. A method of controlling an electrophotographic reproduction process as in claim 4, wherein:
the intrinsic sensitivity is calculated according to the equation
bₘ=bₘ₀+bₘ₁*V₁+bₘ₂*V₂; and
the intrinsic toe is calculated according to the equation
dₘ=dₘ₀+dₘ₁*V₁+dₘ₂*V₂;
wherein bₘ₀, bₘ₁, bₘ₂, dₘ₀, dₘ₁, and dₘ₂ are constants.

6. A method of controlling an electrophotographic reproduction process as in claim 5, wherein:
the corrective charge parameter is calculated according to the equation
V₀ᵢ=V_{0iM}*dₘ+V_{0iB}; and
the corrective exposure parameter is calculated according to the equation
E₀ᵢ=(E_{0iM}*dₘ+E_{0iB})/bₘ;
wherein V_{0iM}, V_{0iB}, E_{0iM}, and E_{0iB} are constants.

7. A method of determining a linear equation for approximating a measured intrinsic sensitivity, bₘ, of a photoconductor charged to a primary charge, V₀, in an electrophotographic recording apparatus, comprising:
selecting a first exposure E₁, and a second exposure, E₂;
generating a plurality of random sensitometric pairs, wherein each of the random sensitometric pairs includes a random intrinsic sensitivity, b_{rand}, and a random intrinsic toe, d_{rand};
calculating a plurality of surface potential pairs using the plurality of random sensitometric pairs, wherein each of the surface potential pairs includes a first photoconductor surface potential, V₁, calculated using the first exposure, E₁, and a second photoconductor surface potential, V₂, calculated using the second exposure, E₂; and
successively approximating a set of constants, bₘ₀, bₘ₁, and bₘ₂, by using the plurality of surface potential pairs in the linear equation bₘ=bₘ₀+bₘ₁*V₁+bₘ₂*V₂, to calculate a plurality of measured intrinsic sensitivities, bₘ, and by and selecting bₘ₀, bₘ₁, and bₘ₂ to minimize a variance between the plurality of measured intrinsic sensitivities, bₘ, and the plurality of random intrinsic sensitivities.

8. A method of determining a linear equation for approximating a measured intrinsic sensitivity, bₘ, as in claim 7, further comprising:
identifying a reference intrinsic contrast, cᵣ; and
wherein the plurality of surface potential pairs are calculated using the equations
V₁=V₀*((1−d_{rand})*exp(−(b_{rand}*E₁)^{c}^{ᵣ})+d_{rand})
and
V₂=V₀*((1−d_{rand})*exp(−(b_{rand}*E₂)^{c}^{ᵣ})+d_{rand}).

9. A method of determining a linear equation for approximating a measured intrinsic sensitivity, bₘ, as in claim 7, further comprising:
identifying a reference intrinsic sensitivity, bᵣ, a reference intrinsic contrast, cᵣ, and a reference intrinsic toe, dᵣ; and
wherein the first exposure, E₁, is selected to produce a value of V₁ that is approximately equal to the product, 0.5*V₀, when V₁ is calculated using the equation
V₁=V₀*((1−dᵣ)*exp(−(bᵣ*E₁)^{c}^{ᵣ})+dᵣ); and
wherein the second exposure, E₂, is selected to produce a value of V₂ that is within approximately 10% of the product, V₀*dᵣ, when V₂ is calculated using the equation
V₂=V₀*((1−dᵣ)*exp(−(bᵣ*E₂)^{c}^{ᵣ})+dᵣ).

10. A method of determining a linear equation for approximating a measured intrinsic sensitivity, bₘ, as in claim 7, wherein:
the plurality of random sensitometric pairs includes twenty-five or more random sensitometric pairs;
the plurality of surface potential pairs includes twenty-five or more surface potential pairs; and
the plurality of measured intrinsic sensitivities includes twenty-five or more measured intrinsic sensitivities.

11. A method of determining a linear equation for approximating a measured intrinsic toe, dₘ, of a photoconductor charged to a primary charge, V₀, in an electrophotographic recording apparatus, comprising:
selecting a first exposure E₁, and a second exposure, E₂;
determining a plurality of random sensitometric pairs, wherein each of the random sensitometric pairs includes a random intrinsic sensitivity, b_{rand}, and a random intrinsic toe, d_{rand};
calculating a plurality of surface potential pairs using the plurality of random sensitometric pairs, wherein each of the surface potential pairs includes a first photoconductor surface potential, V₁, calculated using the first exposure, E₁, and a second photoconductor surface potential, V₂, calculated using the second exposure, E₂; and
successively approximating a set of constants, dₘ₀, dₘ₁, and dₘ₂, by using the plurality of surface potential pairs in the linear equation dₘ=dₘ₀+dₘ₁*V₁+dₘ₂*V₂, to calculate a plurality of measured intrinsic toes, dₘ, and selecting dₘ₀, dₘ₁, and dₘ₂ to minimize a variance between the plurality of measured intrinsic toes, dₘ, and the plurality of random intrinsic toes.

12. A method of determining a linear equation for approximating a measured intrinsic toe, dₘ, as in claim 11, further comprising:
identifying a reference intrinsic contrast, cᵣ; and
wherein the plurality of surface potential pairs are calculated using the equations
V₁=V₀*((1−d_{rand})*exp(−(b_{rand}*E₁)^{c}^{ᵣ})+d_{rand})
and
V₂=V₀*((1−d_{rand})*exp(−(b_{rand}*E₂)^{c}^{ᵣ})+d_{rand}).

13. A method of determining a linear equation for approximating a measured intrinsic toe, dₘ, as in claim 11, further comprising:
identifying a reference intrinsic sensitivity, bᵣ, a reference intrinsic contrast, cᵣ, and a reference intrinsic toe, dᵣ; and
wherein the first exposure, E₁, is selected to produce a value of V₁ that is approximately equal to the product, 0.5*V₀, when V₁ is calculated using the equation
V₁=V₀*((1−dᵣ)*exp(−(bᵣ*E₁)^{c}^{ᵣ})+dᵣ); and
wherein the second exposure, E₂, is selected to produce a value of V₂ that is within approximately 10% of the product, V₀*dᵣ, when V₂ is calculated using the equation
V₂=V₀*((1−dᵣ)*exp(−(bᵣ*E₂)^{c}^{ᵣ})+dᵣ).

14. A method of determining a linear equation for approximating a measured intrinsic toe, dₘ, as in claim 11, wherein:
the plurality of random sensitometric pairs includes twenty-five or more random sensitometric pairs;
the plurality of surface potential pairs includes twenty-five or more surface potential pairs; and
the plurality of measured intrinsic toes includes twenty-five or more measured intrinsic toes.

15. A method of determining a linear equation for approximating a corrective charge parameter, V₀ᵢ, for use in an electrophotographic reproduction apparatus, comprising:
generating a plurality of random intrinsic toes, d_{rand};
calculating a plurality of corrective charge parameter values, V₀ₜ, using the plurality of random intrinsic toes; and
using linear regression, the plurality of corrective charge parameter values, and the plurality of random intrinsic toes to calculate the constants V_{0iM} and V_{0iB} in the linear equation
V₀ₜ=V_{0tM}*d_{rand}+V_{0iB}.

16. A method of determining a linear equation for approximating a corrective exposure parameter, E₀ᵢ, for use in an electrophotographic reproduction apparatus, comprising:
generating a plurality of random sensitometric pairs, wherein each random sensitometric pair includes a random intrinsic sensitivity, b_{rand}, and a random intrinsic toe, d_{rand};
calculating a plurality of corrective exposure parameter values, E₀ᵢ, using the plurality of random sensitometric pairs; and
using linear regression, the plurality of corrective charge parameter values, and the plurality of random intrinsic toes to calculate the constants V_{0iM} and V_{0iB} in the linear equation
E₀ᵢ=(E_{0tM}*d_{rand}+E_{0iB})/b_{rand}.

17. A method of determining an intrinsic operating sensitivity, b, of a photoconductor relative to a primary charge, V₀, applied to a photoconductor before exposure in an electrophotographic recording apparatus, comprising:
identifying a reference primary charge, V₀ᵣ;
identifying p, wherein p is a power dependence of the intrinsic sensitivity on the primary charge; and
calculating the operating intrinsic sensitivity using the reference primary charge, the power dependence of the intrinsic sensitivity on the primary charge, and the equation
b=bᵣ*(V₀/V₀ᵣ)^{-p}.

18. A method of determining an intrinsic operating sensitivity, b, of a photoconductor relative to a primary charge, V₀, as in claim 17, wherein the reference primary charge, V₀ᵣ, is identified to be 500 volts.

19. A method of determining an intrinsic operating toe, d, of a photoconductor relative to a primary charge, V₀, applied to a photoconductor before exposure in an electrophotographic recording apparatus, comprising:
identifying a reference primary charge, V₀ᵣ;
identifying m, wherein m is a linear dependence of the intrinsic toe on the primary charge; and
calculating the operating intrinsic toe using the reference primary charge, the linear dependence of the intrinsic toe on the primary charge, and the equation
d=dᵣ−m*(V₀−V₀ᵣ).

20. A method of determining an intrinsic operating toe, d, of a photoconductor relative to a primary charge, V₀, as in claim 19, wherein the reference primary charge, V₀ᵣ, is identified to be 500 volts.
